(19) United States
(12) Patent Application Publication
(10) Pub. No.: US 2007/0017546 A1
(43) Pub. Date: Jan. 25, 2007

(54) Orthodonthic flossing device

(75) Inventor: Oocal Brown, Tangerine, FL (US)

Correspondence Address: Oocal Brown, PO Box 3, Tangerine, FL, 32777, US

(73) Assignee: Dino Bite Inc., Tangerine, FL (US)

(21) Appl. No.: 11/189,054

(22) Filed: Jul. 25, 2005

(51) Int. Cl. A61C 15/00

(52) U.S. Cl. 132/323

(57) ABSTRACT

A disposable dental flossing device utilized by patients with orthodontic appliance generally worn to correct teeth misalignment. The appliance is adjoined to the teeth by brackets and is connected to each other by an arched wire which is secured by bands and or wire linkage. The orthodontic flosser is comprised of two arms, the inner arm which is slightly curved outward and rounded in shape being connected to the outer arm by the floss line which is used to dislodge particles between the teeth of the orthodontic patient. The outer arm is connected to the bridge of the orthodontic flossing device that joins the inner arm and the handle together. The handle end includes a thin tapered point that also dislodges particles from the orthodontic patient's teeth and appliance.

### BRIEF DESCRIPTION OF THE DRAWINGS

FIG. 3 is a cut-away side view of the gum(,) teeth, and braces with present invention positioned in relation to usage(.)

### DETAILED DESCRIPTION OF THE PREFERRED EMBODIMENTS

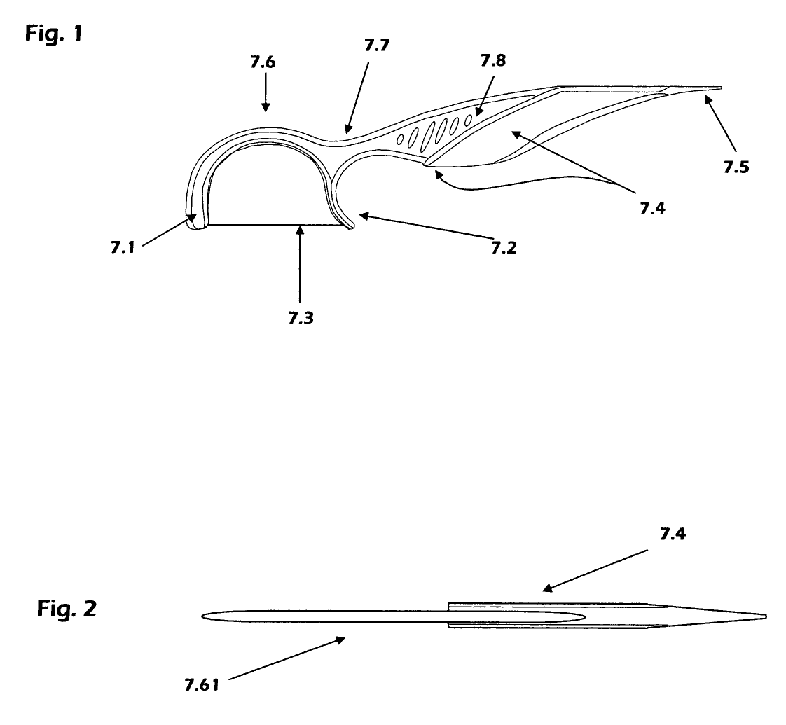

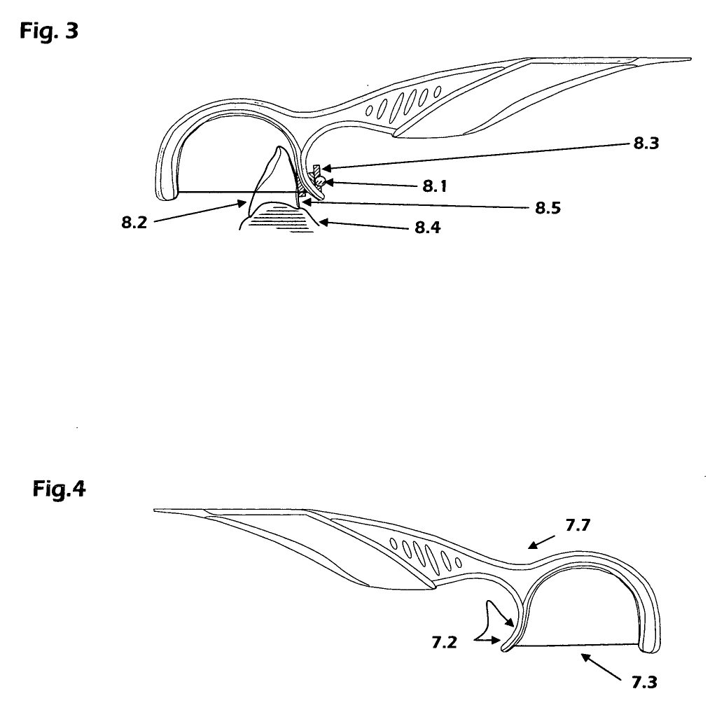

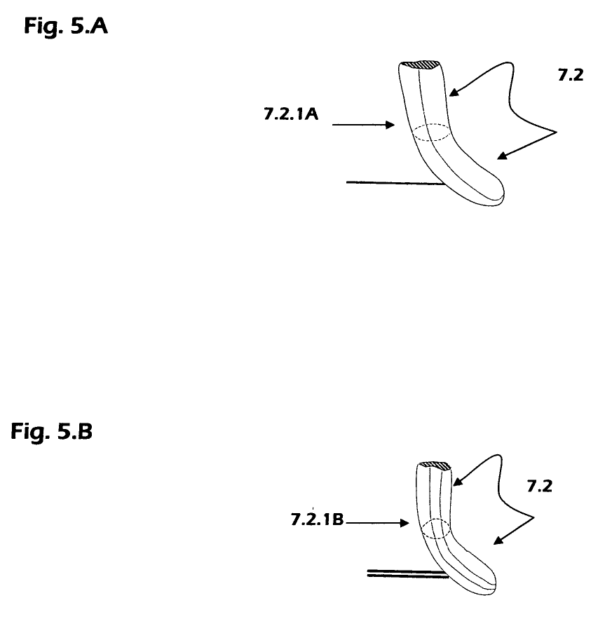

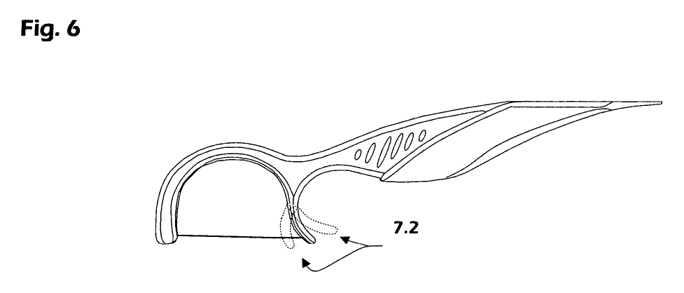

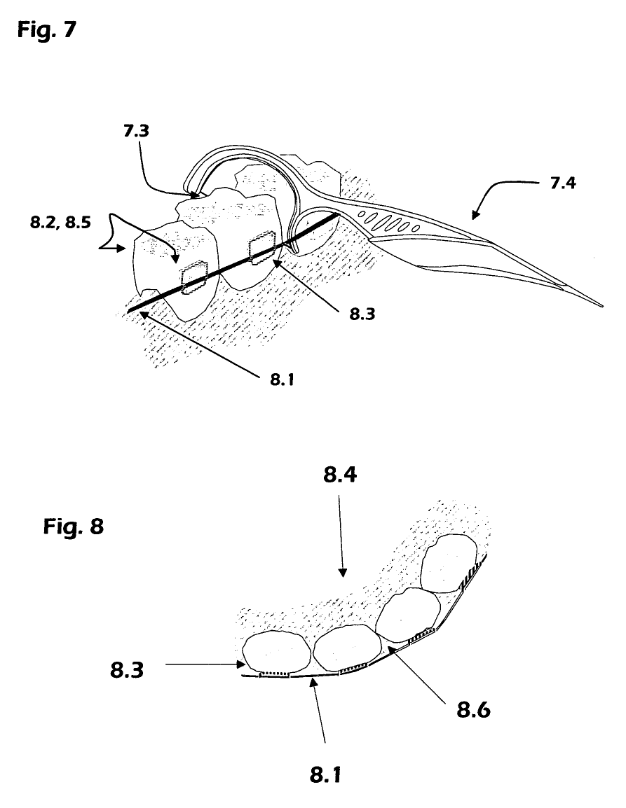

FIG. 3 is a cut-away side view of the gum, teeth and braces. The cut away view of the gum line 8.4 and teeth (both inner surface 8.2 and outer surface 8.5) illustrates coloration of orthodontic flossing device and floss position. Brackets 8.3 are affixed to the outer surface of the patient's teeth with a bonding agent. As the patient's teeth move they are manipulated to the desired position with an arched wire 8.1.

FIG. 6 is a motion view indicating movement of inner arm 7.2.3. This embodiment portrays the inner arm 7.2 in flex range of motion that allows floss to slide food particles from patient's teeth and gum line area.

### REFERENCES CITED

U.S. Patent Document 677,947 July, 1901 Cowan 132/324 4,192,230 March, 1980 Johnson 132/32

### BACKGROUND OF THE INVENTION

The orthodontic dental flossing device is used for removing particles from between the teeth. In general, disposable floss is comprised of a plastic handle having two adjoining arms. Floss is connected to both arms; usually the user/patient would place the floss between two teeth with one arm positioned on the interior part of the mouth and other arm at the exterior part of the mouth. A downward motion would be used to get the floss to the gum line. The floss would then be maneuvered in order to dislodge or eject food particles and or plaque.

The above procedure cannot be sufficiently performed on a patient having orthodontic appliance/braces installed in their mouth.

Generally orthodontic appliance/braces are comprised of brackets that are attached to the teeth. Each bracket is held in place by a wire that is secured by bands. During the course of treatment the wire and bands maybe changed to affect teeth movement. As treatment progresses and teeth gets closer together, removing particles and plaque becomes more difficult with normal brushing. The wires also pose a difficult barrier to traditional flossing.

The orthodontic flossing device is utilized in the same manner as a traditional flosser would. However, the uniquely designed inner arm is sized and shaped to fit between the small clearance of the teeth, bracket and the wire. The user/patient would position the inner arm of the orthodontic flossing device to fit between the teeth and wire in order to manipulate the floss at the gum line thereby dislodging or removing food particles and or plaque.

### SUMMARY OF THE INVENTION

The orthodontic flossing device is designed to specifically maneuver between the tight spacing of the attached brackets, wires and bands of the patient's teeth, allowing the patient to easily remove particles from teeth and orthodontic appliance.

The present invention includes an inner arm rounded and sized to maneuver in a wide range of motion between the patient's teeth and the fixed orthodontic appliance.

Floss line is thin enough to allow easy movement between closely set teeth.

The inner arm is thin and flexible to allow wider range of motion and more rigid floss to affect thorough cleaning.

The inner arm is connected by the neck to the grip handle. Gripped handle provides adequate hold and flexibility for the patient to comfortably maneuver orthodontic flossing device between teeth and orthodontic appliance.

The tipped portion is connected to the end portion of the handle that allows patient to utilize pointed area of the tip to loosen and move particles from orthodontic appliance, teeth and gum areas. The tip area is smaller in order to allow easy access in the harder to reach areas.

### BRIEF DESCRIPTION OF THE DRAWINGS

FIG. 1 is a left side view of the present invention.

FIG. 2 is a top view of present invention.

FIG. 3 is a cut-away side view of the gum, teeth, and braces with present invention positioned in relation to usage.

FIG. 4 is a right side view of present invention.

FIG. 5A of preferred embodiment is an enlarged cross-sectional view of ellipse inner arm (7.2) with floss line attached of present invention.

FIG. 5B is an enlarged cross-sectional view of oval shaped arm with floss line attached of present invention.

FIG. 6 is a motion view indicating movement of inner arm.

FIG. 7 is an angled view depicting the usage of the orthodontic flossing device particularly in the area of the inner arm with the spacing between the teeth, brackets and wire.

FIG. 8 is a top view showing the gum, teeth, brackets, wire and bands.

### DETAILED DESCRIPTION OF THE PREFERRED EMBODIMENTS

FIG. 1 is a left side view of present invention. FIG. 1 depicts embodiment of the outer arm 7.1 that joins the bridge 7.6. The inner arm 7.2 is connected to both the neck 7.7 and the bridge 7.6 to form the head of the orthodontic flossing device. One end of the floss line 7.3 is affixed in the end outer arm and the other end of the floss line is affixed to the end of the inner arm. Inlaid grooves 7.8 provides uneven surface to prevent patient's fingers from slipping while flossing. The neck 7.7 connects the handle 7.4 to the head 7.6 of the orthodontic flossing device. The tip 7.5 is connected to the end portion of the handle.

FIG. 2 is a top view of the present invention showing the head, neck and partial handle portion 7.61 in relation to the handle 7.4

FIG. 3 is a cut-away side view of the gum, teeth and braces. The cut away view of the gum line 8.4 and teeth (both inner surface 8.2 and outer surface 8.5) illustrates coloration of orthodontic flossing device and floss position. Brackets 8.3 are affixed to the outer surface of the patient's teeth with a bonding agent. As the patient's teeth move they are manipulated to the desired position along the arched wire 8.1.

FIG. 4 is a right side view of present invention. The embodiment of the invention is unchanged and equal in usage and appearance as FIG. 1.

FIG. 5A is an angled cross-sectional view of inner arm 7.2. This embodiment focuses on the rounded curve and the ellipse shaped inner arm 7.2.1A that will allow the inner arm to easily fit between the spacing of the patient's teeth and orthodontic braces. The outer curve allows present invention to freely move under arched wire to accomplish full flossing activity.

FIG. 5B is an angled cross-sectional view of inner arm 7.2. This embodiment focuses on the rounded curve and the oval shaped inner arm 7.2.1B that will allow the inner arm to easily fit between the spacing of the patient's teeth and orthodontic braces. The outer curve allows present invention to freely move under arched wire to accomplish full flossing activity.

FIG. 6 is a motion view indicating movement of inner arm 7.2. This embodiment portrays the inner arm 7.2 in flex range of motion that allows floss to slide food particles from patient's teeth and gum line area.

FIG. 7 is an angled view depicting the usage of the orthodontic flossing device particularly the area of the inner arm with the spacing between the teeth, brackets, and wire. As the patient maneuvers the orthodontic flossing device the inner arm 7.2 and the floss line 7.3 is symbiotic to the floss line's tension allowing greater range of motion, thus providing the patient thorough flossing.

FIG. 8 is a top view showing the gum, teeth, brackets, wire and bands. The area that 8.6 denote is where the inner arm would be placed in order to gain complete access of teeth and gum area.

What I claim is:

1. A dental flossing device small and slender in shape, comprising of head and handle portions. Said head portion is constructed of two arms. The outer arm of the present invention is straighter and slender at the bottom and is curved at the top. Top portion of said arm is connected to a bridge that joins the neck and flexible inner curved arm to the handle portion of present invention. The outer arm of the present invention is attached to a floss line (that is slender enough to slide between very tightly engaged teeth) which is connected to a more slender curved end. The head which is comprised of both outer and inner arms are joined to the handle whereby the user's fingers maintain a firm grip to affect thorough flossing.

2. The present invention according to claim 1, wherein:
Said arms hold floss line/tape that is thin enough to enter the tightest spacing between the patient's teeth, thus enabling the patient to move the floss easily without impediment.

3. The present invention according to claim 1, wherein:
The inner arm of the present invention is slender and rounded in shape providing flexibility to said arm when tension is placed on floss line, giving the open end portion of inner arm the ability to extend outward and inward while flossing.

4. The present invention according to claim 1, wherein:
The handle is comprised of a series of inlaid parallel grooves which interrupts the smooth surface in order to create grip points, thus providing adequate hold for patient while flossing.
